(19) United States
(12) Patent Application Publication
(10) Pub. No.: US 2008/0062635 A1
(43) Pub. Date: Mar. 13, 2008

(54) Draw-Open Structure for Assembling Hard Disks

(76) Inventor: Tien-Lu Chang, Taoyuan City (TW)

Correspondence Address: HDSL, 4331 STEVENS BATTLE LANE, FAIRFAX, VA, 22033, US

(21) Appl. No.: 11/530,879

(22) Filed: Sep. 11, 2006

(51) Int. Cl. G06F 1/16

(52) U.S. Cl. 361/685

(57) ABSTRACT

A draw-open structure for assembling hard disks is used to accommodate a plurality of hard disk devices. Such structure is mainly constituted of a computer housing. An accommodating trough is provided at a lower portion of a front end of the housing. Both sides of the bottom of the accommodating trough have a sliding path, respectively. Both sides of the accommodating trough have a fixing rod, respectively. Further, the accommodating trough is used to accommodate a box body. A plurality of storage units is accommodated in the box body. Both side faces of the box body are provided with a cambered sliding groove thereon for accommodating the fixing rod. Further, the bottom of the box body is provided with a connecting unit. The connecting unit has a plurality of connecting interfaces thereon for connecting and fixing the plurality of storage units. Finally, the surface of the front end of the box body has a handle, by which the user can draw open the box body. With the above arrangement, the user can rapidly replace and assemble plural sets of storage units.

### BACKGROUND OF THE INVENTION

1. Field of the Invention

The present invention relates to a computer host, and in particular to a structure of a computer housing for accommodating a plurality of hard disk devices therein.

2. Description of Prior Art

With the advancement of modern technology, computers play a more and more important role in daily life. The functions of the computer have been continuously widened with the development of its peripheral hardware. Recently, not only a main board, CPU or hard disk is disposed within a computer host, but also interface cards necessary for other peripheral devices, display card and VCD-RW or DVD-RW are additionally disposed therein, thereby to make the applications of the computer system become versatile.

Therefore, since the functions of the computer increase continuously, the storage capacity of a hard disk is also required to become large accordingly. Although the capacity of the hard disk itself continuously increases with the progress of the technology, it still cannot satisfy the demand of users. Thus, plural sets of hard disks are now arranged in the computer host, thereby to provide sufficient storage capacity for the user.

However, since the internal space of the computer host is limited and various electronic elements should be arranged therein, in order to efficiently use the internal space of the computer host, conventionally, the plural sets of hard disk devices are arranged within the computer host parallel to each other. Further, a connecting interface is provided at a rear end of the hard disk, thereby to achieve the demand for enlarging the storage capacity of the hard disk. Although the above measure can enlarge the number of the hard disk, when the user intends to replace the hard disk within the host, he has to first open and disassembles the housing of the host and then manually detaches the connecting interface provided at the rear end of the hard disk. Such operation not only causes a great inconvenience to the user, but also may easily damage other elements due to the collision thereof during the detaching operation.

In order to solve the above drawbacks, a conventional art proposes a draw-open structure of a hard disk box, which is provided on the computer host. Further, a connecting circuit board provided at the rear end of the box body is electrically connected to the main board. Also, an opening is provided on the main board of the computer host, so that the user can easily detach the hard disk device without opening the housing of the computer, thereby to increase the convenience in replacing the hard disk. Although the structure of the hard disk box can provide the user with the convenience in replacing the hard disk, the structure of the hard disk box is too bulky, which adversely reduces the number of the hard disks allowable to be disposed therein. Therefore, it is an important issue for those skilled in this art to propose a novel and advantageous structure satisfying both convenience and large capacity.

### SUMMARY OF THE INVENTION

In view of the above drawbacks, the present invention is to provide a draw-open structure for assembling hard disks, so that the user can rapidly replace a storage unit. Further, the front end of the computer host is provided with a box body for accommodating plural sets of storage units and a means is provided to allow the user to directly draw open the box body. With the above arrangement, the user can rapidly swap the storage unit without opening the computer host.

The present invention provides a draw-open structure for assembling hard disks. Such structure is mainly constituted of a computer housing. An accommodating trough is provided at a lower portion of a front end of the housing. Both sides of the bottom of the accommodating trough have a sliding path, respectively. Both sides of the accommodating trough have a fixing rod, respectively. Further, the accommodating trough is used to accommodate a box body. A plurality of storage units is accommodated in the box body. Both side faces of the box body are provided with a cambered sliding groove thereon for correspondingly accommodating the fixing rod. Further, the bottom of the box body is provided with a connecting unit. The connecting unit has a plurality of connecting interfaces thereon for connecting and fixing the plurality of storage units. Finally, the surface of the front end of the box body has a handle, by which the user can draw open the box body.

### BRIEF DESCRIPTION OF THE DRAWINGS

FIG. 1 is a perspective front view showing the structure of the present invention;

FIG. 2 is a perspective rear view showing the structure of the present invention;

FIG. 3 is a schematic view (I) showing the operation of the present invention;

FIG. 4 is a side view showing the operation of the present invention; and

FIG. 5 is a schematic view (II) showing the operation of the present invention.

### DETAILED DESCRIPTION OF THE INVENTION

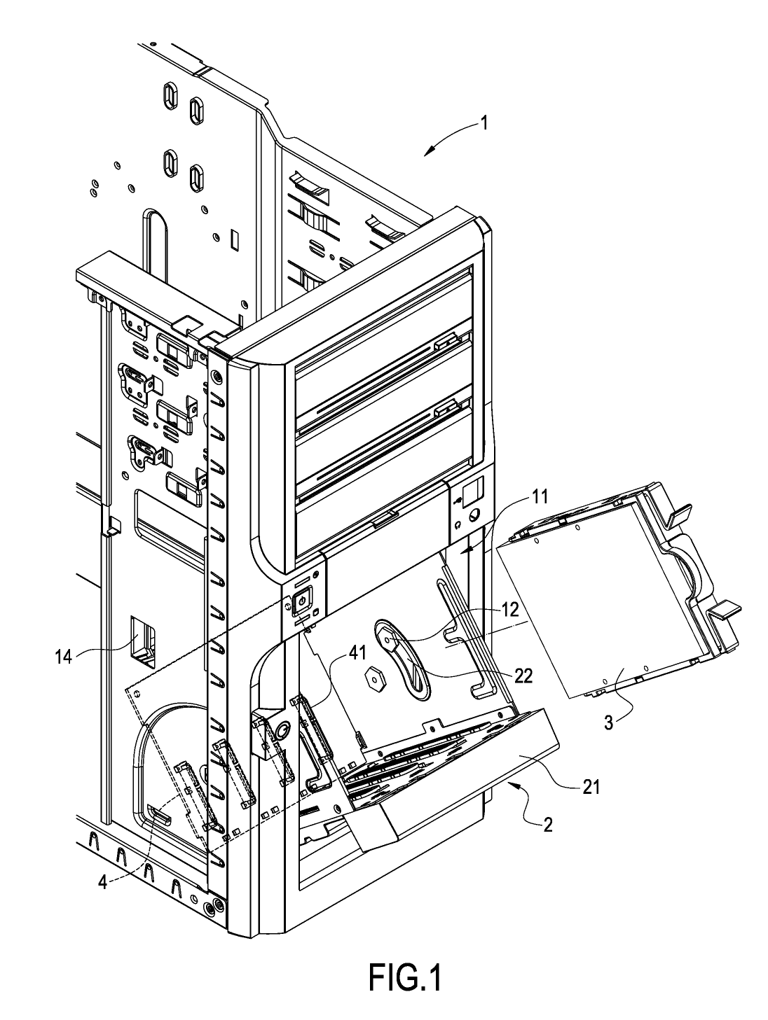

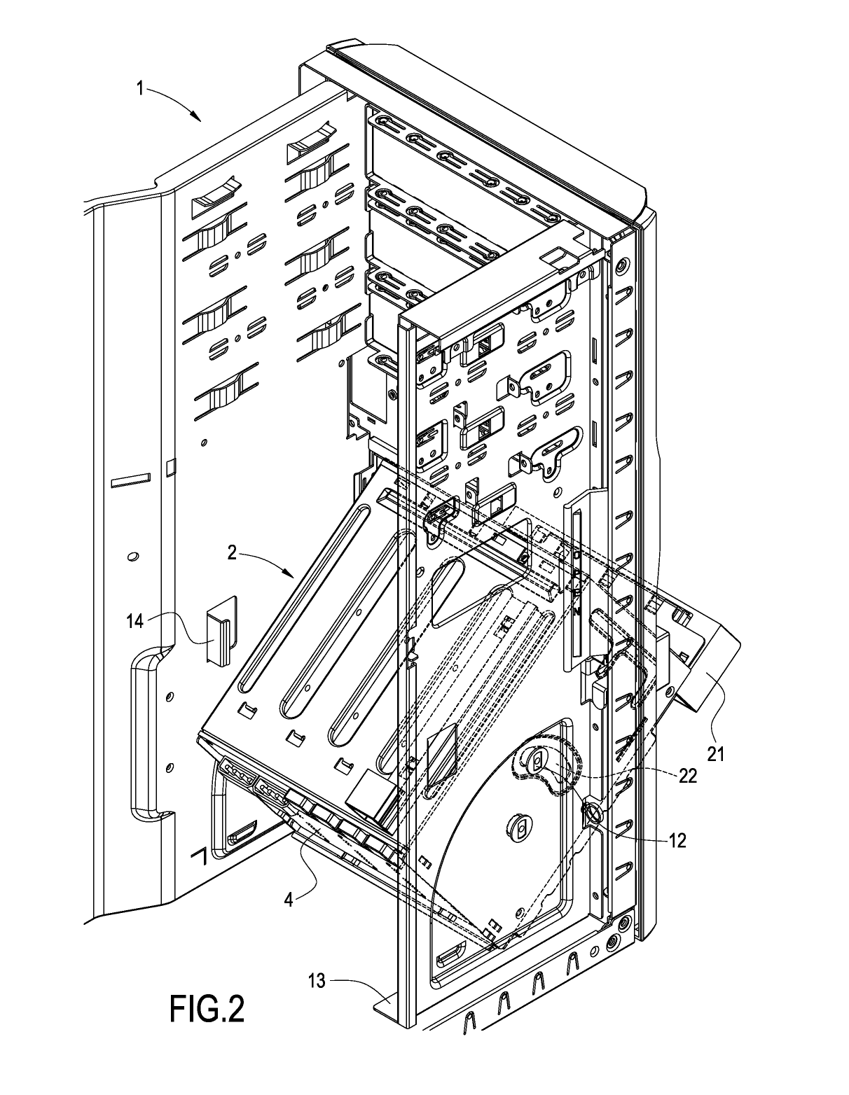

With reference to FIG. 1 and FIG. 2, which are the perspective front view and the perspective rear view showing the structure of the present invention, respectively. According to the present invention, the structure for assembling hard disks is mainly constituted of a computer housing 1. An accommodating trough 11 is provided at a lower portion of a front end of the housing 1. The accommodating trough 11 is encircled by the case of the housing 1. Both sides of the accommodating trough are provided with a fixing rod 12, respectively. Further, both sides of the bottom of the accommodating trough 11 are provided with a sliding path 13, respectively. Finally, both sides of the rear end of the accommodating trough 11 are provided with a fixing base 14, respectively. The housing 1 has a box body 2 thereon for accommodating at least one storage unit 3. In the present embodiment, the storage unit 3 is a hard disk. The box body 2 is accommodated in the accommodating trough 111 of the housing 1. The front end of the box body 2 is provided with a handle 21 for drawing open the box body 2. Further, both side faces of the box body 2 are provided with a cambered sliding groove 22, respectively. The sliding groove 22 is used for accommodating the fixing rod 12 provided on the accommodating trough 11. Both sides of the bottom of the box body 2 are just disposed across the two sliding paths 13, so that the box body 2 can move forwardly and backwardly. Finally, the bottom of the box body 2 has a connecting unit 4 on which plural sets of parallel connecting interfaces 41 are provided for electrically connecting and fixing the storage unit 3.

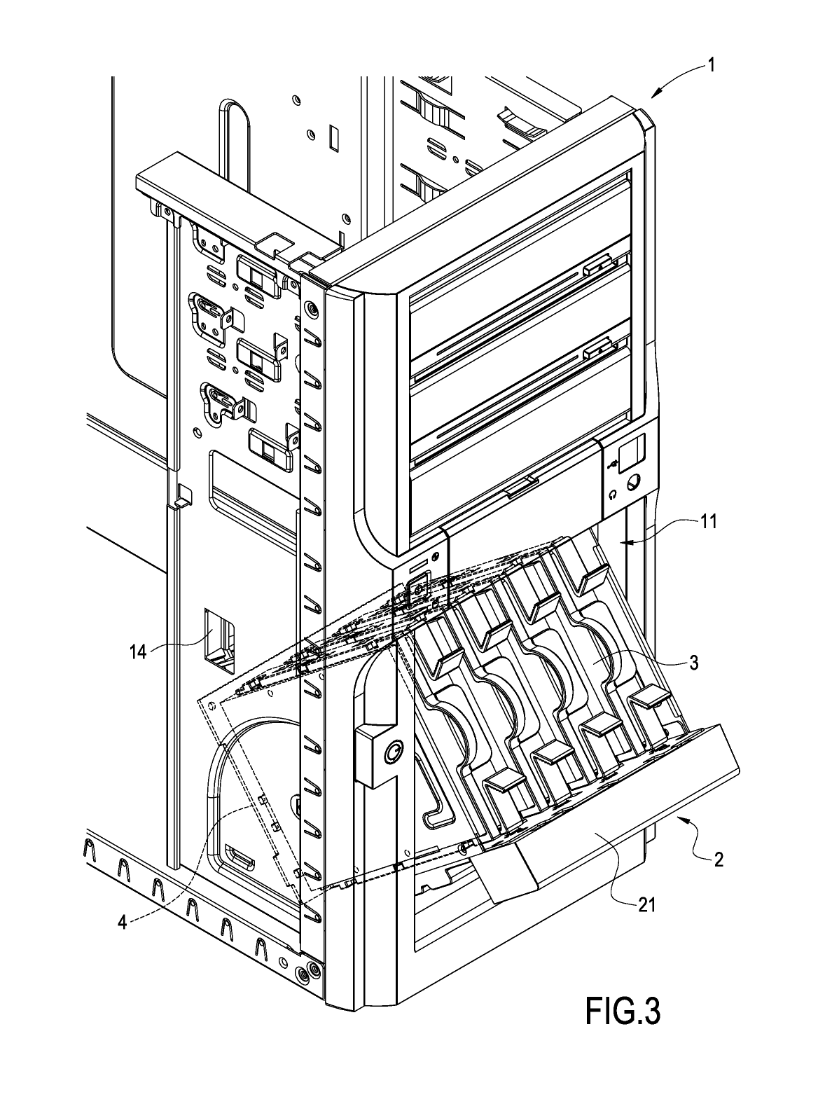

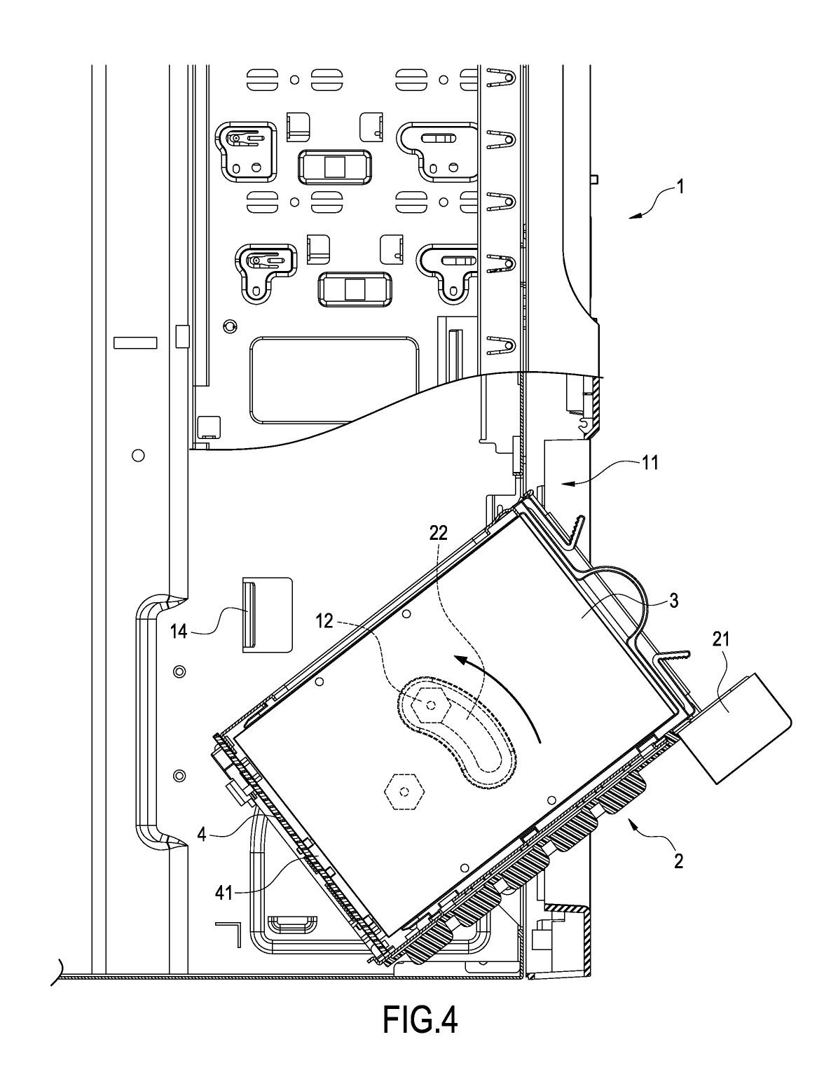

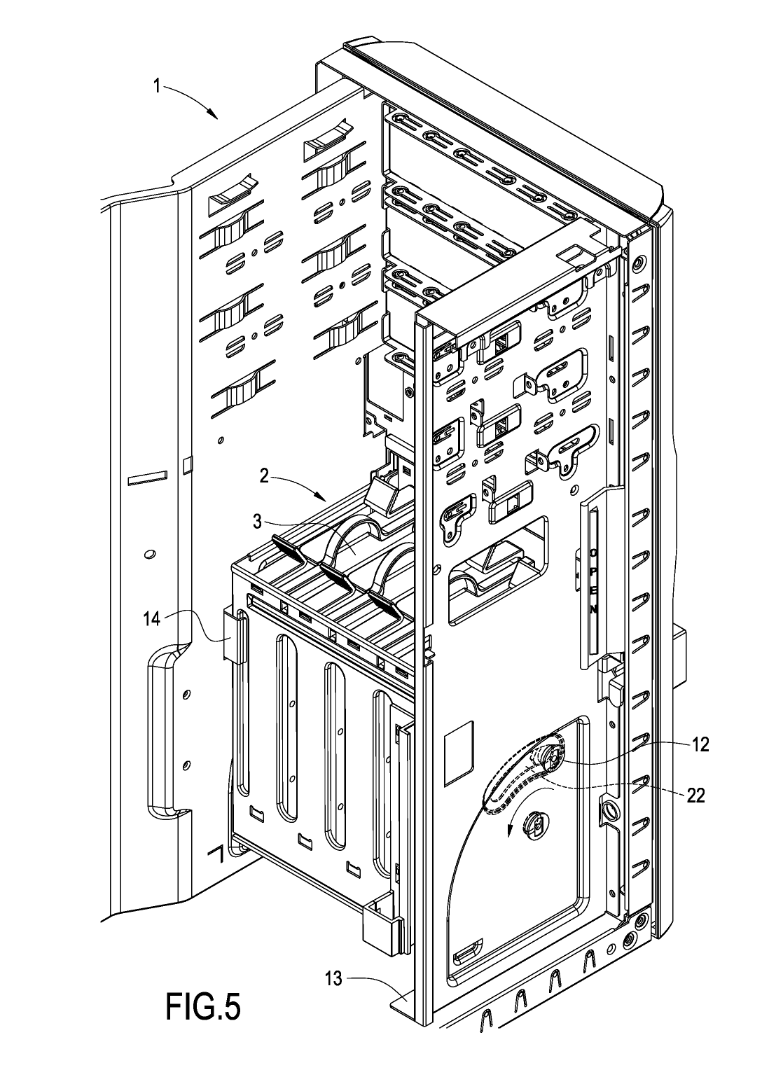

With reference to FIGS. 3 to 5, they are the schematic views showing the operation of the present invention. It can be seen that when the user intends to add or replace the storage unit 3 within the computer host, he can use the handle 21 to draw open the box body 2. At this time, through the sliding grooves 22 on both sides, the box body 2 slides along the sliding paths 14. Therefore, when the user draws open the box body 2, the box body 2 is positioned to an outwardly inclined posture, as shown in the side view of FIG. 4. In this way, the opening on the box body 2 is directed toward the outside, so that it is convenient for the user to connect the storage unit 3 via the connecting unit 4 provided on the bottom of the box body 2 and the connecting interfaces 41. As a result, the storage unit can be electrically connected with the electronic assembly within the computer housing 1. Such an electrical connection is conventional and thus the description thereof is omitted. Further, after the user has finished adding or replacing the storage unit 3, he can push the box body 2 toward the accommodating trough 11 of the computer housing 1 via the handle 21 to return its original position. With the sliding grooves 22, the box body 2 can finally abut against the fixing base 14 at the rear end of the accommodating trough 11 to fix the position of the box body 2. With the above operations, the user can easily replace the storage unit 3 within the computer host.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A draw-open structure for assembling hard disks, used to accommodate plural sets of hard disks, comprising:
a computer housing having an accommodating trough hereon; and
a box body accommodated in the accommodating trough of the housing, the bottom of the box body having a connecting unit, and the connecting unit being provided with a plurality of connecting interfaces thereon for electrically connecting the hard disks.

2. The draw-open structure for assembling hard disks according to claim 1, wherein both sides of the accommodating trough have a fixing rod, and both side faces of the box body have a sliding groove for correspondingly accommodating the fixing rod.

3. The draw-open structure for assembling hard disks according to claim 1, wherein both sides of the bottom of the accommodating trough have a sliding path.

4. The draw-open structure for assembling hard disks according to claim 1, wherein both side plates of the rear end of the accommodating trough have a fixing base.

5. The draw-open structure for assembling hard disks according to claim 1, wherein a frontal end of the box body has a handle.

6. The draw-open structure for assembling hard disks according to claim 1, wherein a sliding groove is formed into a cambered shape.
